(19) United States
(12) Patent Application Publication
(10) Pub. No.: US 2008/0236406 A1
(43) Pub. Date: Oct. 2, 2008

(54) Cooking implement

(76) Inventors: Warren Schaub, Langhorne, PA (US); Margaret A. Schaub, Langhorne, PA (US)

Correspondence Address: JAMES RAY & ASSOCIATES, 2640 PITCAIRN ROAD, MONROEVILLE, PA, 15146, US

(21) Appl. No.: 12/079,961

(22) Filed: Mar. 31, 2008

Related U.S. Application Data
(60) Provisional application No. 60/920,862, filed on Mar. 31, 2007.

(51) Int. Cl. A47J 43/00

(52) U.S. Cl. 99/427

(57) ABSTRACT

A cooking implement is provided. Such cooking implement includes an elongated extending arm manufactured from a first predetermined material and having a first predetermined size, shape and length. A holding member manufactured from a second predetermined material and having a second predetermined size and shape is operably connected to a first end of the elongated extending arm. The holding member had an opening at a first predetermined end thereof. Such opening has a third predetermined size and shape and is for receiving at least a portion of at least one of an item of food, a food container, a cooking container, a handle of a food container, and a handle of a cooking container, such that the at least one of such item of food, such food container, and such cooking container can be at least one of lifted and extended over a heating source.

### CROSS REFERENCE TO RELATED APPLICATION

This patent application is related to and claims priority from U.S. Provisional Patent Application Ser. No. 60/920,862 filed Mar. 31, 2007.

### FIELD OF THE INVENTION

The present invention relates, in general, to cooking implements and accessories and, more particularly, this invention relates to an elongated implement for use in cooking popcorn and other foods.

### BACKGROUND OF THE INVENTION

Prior to the conception and development of the present invention, skillets, pots, and the like, as are generally well known in the prior art, have been used to cook foods, such as popcorn, over campfires and open flames. However, cooking can be dangerous and frightening. Often times, adults and children attempting to cook food get too close to the heating source and are injured by heat, smoke, flames and a combination thereof. A need exists for a device which will allow a user to cook comfortably and at a safe distance from the heating source.

Specifically of interest to the present invention are the following: Crawford, U.S. Pat. No. DES. 338,804 provides the ornamental design for an extendable popcorn popper handle.

Christen, Jr., U.S. Pat. No. DES. 245,219 provides the ornamental design for a popcorn popper.

Johnston, U.S. Patent No. provides an extension type holder for food handling implements which impales food or prepackaged popcorn for holding same over a fire.

Churcott, Canadian Patent No. CA 2,412,138 provides a is securable to the handle of a prepackaged self-contained aluminum popcorn container thereto such that the popcorn may be popped over an open flame, a stovetop, a fire within a fireplace, and the like.

Westfall, U.S. Pat. No. 6,957,492, provides a cooking implement having a long handle and utensil end, such implement being capable of being disassembled for storage and transportation.

Holliday, U.S. Pat. No. 5,628,244 discloses a food roasting device having a plurality of spirals, such spirals having a diameter greater than the diameter of a food item.

### SUMMARY OF THE INVENTION

The present invention provides a cooking implement. Such cooking implement includes an elongated extending arm manufactured from a first predetermined material and having a first predetermined size and a first predetermined shape and a first predetermined length. A holding member is operably connected to a first end of the elongated extending arm. The holding member is manufactured from a second predetermined material and has a second predetermined size and a second predetermined shape. The holding member has an opening at a first predetermined end thereof. Such opening has a third predetermined size and a third predetermined shape, and is for receiving at least a portion of at least one of an item of food, a food container, a cooking container, a handle of a food container, and a handle of a cooking container, such that the at least one of such item of food, such food container, and such cooking container can be at least one of lifted and extended over a heating source.

### OBJECTS OF THE INVENTION

It is, therefore, one of the primary objects of the present invention to provide a cooking implement for use in cooking prepackaged “ready to heat” popcorn over open flames and stovetops.

Another object of the present invention is to provide a cooking implement having an elongated handle which will enable a user to cook over a heating source from a safe distance.

Still another object of the present invention is to provide a cooking apparatus which includes a handle which will prevent a user cooking with the apparatus from getting burned.

Yet another object of the present invention is to provide a cooking implement which has a plate type member capable of receiving and holding a wire type handle of a prepackaged container of popcorn capable of being cooked over an open flame and a stovetop.

Still another object of the present invention is to provide a device which will enable parents and other caregivers to feel more comfortable about allowing children to cook due to the safer distance the invention provides between a user and a cooking source.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective view of the invention according to one embodiment of the invention.

FIG. 2 is a partial perspective view of the invention according to one embodiment of the invention.

FIG. 3 is a partial perspective view of the invention according to one embodiment of the invention in which two raised panels are operably connected to a substantially flat portion of such holding member to form a slot-type opening.

FIG. 4 is a partial perspective view of the invention according to one embodiment of the invention in which the holding member is formed in two halves and is hinged.

FIG. 5 is a cross sectional view taken along the lines IV-IV of FIG. 4.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

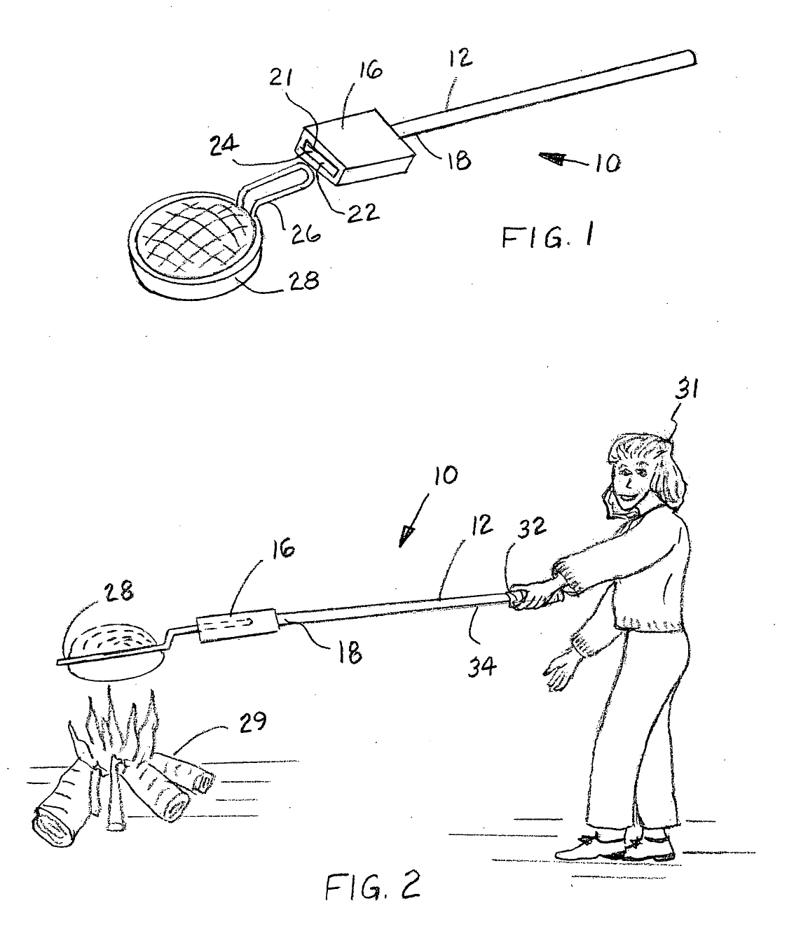

Reference is now made, more particularly, to FIGS. 1-5.

A cooking implement, generally designated 10, is provided. Such cooking implement 10 includes an elongated extending arm 12 manufactured from a first predetermined material and having a first predetermined size, a first predetermined shape and a first predetermined length.

It is presently preferred that such first predetermined material is heat resistant. It is further presently preferred that such first predetermined material is a metal. It is presently preferred that such metal is aluminum.

It is presently preferred that such first predetermined length is between about 14.0 inches and 32.0 inches long. It is further presently preferred that such first predetermined shape is substantially cylindrical.

A holding member 16 is operably connected to a first end 18 of such elongated extending arm 12. Such holding member 16 is manufactured from a second predetermined material and has a second predetermined size and a second predetermined shape.

It is presently preferred that such second predetermined material is heat resistant. It is further presently preferred that such second predetermined material is a metal. It is presently preferred that such second predetermined material is aluminum.

It is presently preferred that such second predetermined shape is substantially rectangular.

It is further presently preferred that such first predetermined material and such second predetermined material are substantially identical.

Such holding member 16 includes an opening 22 at a first predetermined end 21 of such holding member 16. Such opening 22 has a third predetermined size and a third predetermined shape, and is for receiving at least a portion of at least one of an item of food, a food container, a cooking container, a handle of a food container, and a handle of a cooking container, such that the at least one of such item of food, such food container, and such cooking container can be at least one of lifted and extended over a heating source 29.

It is presently preferred that such holding member 16 is between about 4.0 inches and 6.0 inches long. It is presently preferred that such holding member 16 is between about 1.5 inches and 2.5 inches wide. It is presently preferred that such holding member is between about 0.25 inches and 1.0 inches thick.

It is presently preferred that such opening 22 is a slot-type opening 24. It is presently most preferred that such opening is a slot-type opening 24 for receiving at least a portion of a wire handle 26 of a pre-packaged ready-to-pop style container 28 of popcorn capable of being heated by holding such container 28 over a heating source 29.

Such heating source may be at least one of a campfire, an open flame, a charcoal fire, a stove top, a fire contained within a fireplace, and the like. Such heating source is meant to include any type of heating source which a user 31 may hold food and cooking containers over, especially heating sources useful for cooking ready-to-pop popcorn.

It is presently preferred that such cooking implement 10 includes a heat resistant handle member 32 operably connected to a second predetermined end 34 of such elongated extending arm 12. The heat resistant handle member 32 is manufactured from a third predetermined material and has a fourth predetermined size and a fourth predetermined shape.

It is presently preferred that such third predetermined material is wood. It is further presently preferred that such fourth predetermined shape is substantially cylindrical. It is presently preferred that such heat resistant handle member 32 is between about 4.0 inches and 8.0 inches long.

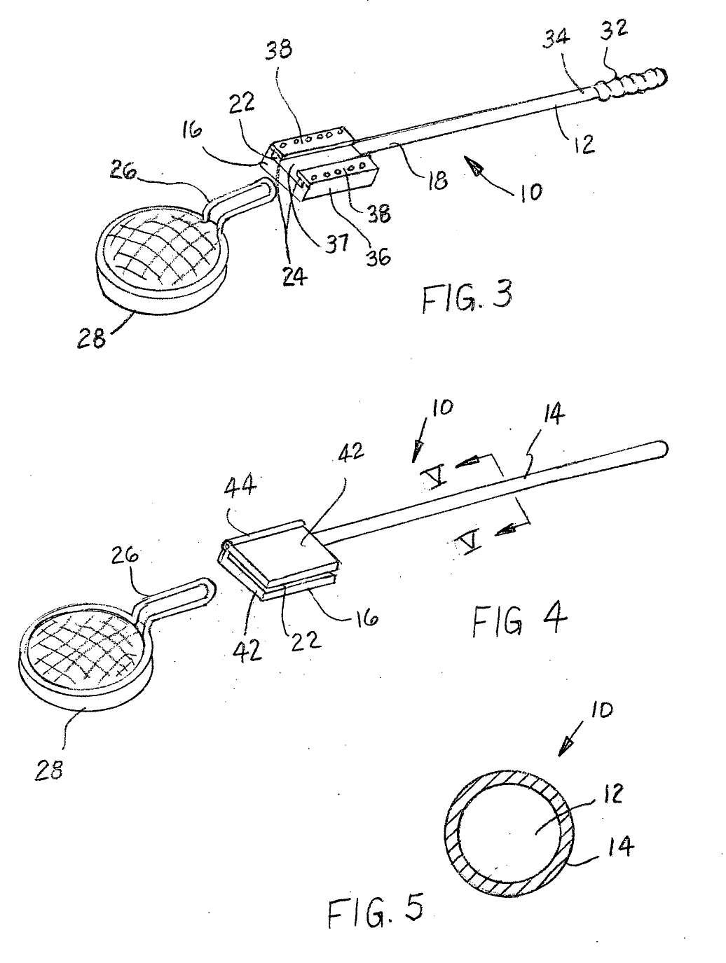

According to one embodiment of the invention, as illustrated in FIG. 3, such holding member 16 includes a substantially flat portion 36 and two raised panel members 38 operably connected to the substantially flat portion 36 on a first predetermined side 37 thereof, the raised panel members 38 are parallel to the substantially flat portion 36, thereby creating such opening 22.

According to another embodiment of the present invention, as illustrated in FIG. 4, such holding member 16 is formed in two halves 42 and is hinged 44.

According to yet another embodiment, as illustrated in FIGS. 4-5, such cooking implement 10 includes an insulated ring 14 disposed around at least a portion of the elongated extending arm 12 at a predetermined location thereon. The insulating material may be Supertherm™, a ceramic insulator manufactured by Superior Products International, II, Inc. Kansas City, Kans.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A cooking implement comprising:
a. an elongated extending arm manufactured from a first predetermined material and having a first predetermined size and a first predetermined shape and a first predetermined length; and
b. a holding member being operably connected to a first end of said elongated extending arm, said holding member being manufactured from a second predetermined material and having a second predetermined size and a second predetermined shape, said holding member further having an opening at a first predetermined end thereof, said opening having a third predetermined size and a third predetermined shape, for receiving at least a portion of at least one of an item of food, a food container, a cooking container, a handle of a food container, and a handle of a cooking container, such that said at least one of such item of food, such food container, and such cooking container can be at least one of lifted and extended over a heating source.

2. A cooking implement according to claim 1 wherein said cooking implement includes a heat resistant handle member operably connected to a second predetermined end of said elongated extending arm, said heat resistant handle member being manufactured from a third predetermined material and having a fourth predetermined size and a fourth predetermined shape.

3. A cooking implement according to claim 1 wherein said opening is a slot-type opening.

4. A cooking implement according to claim 1 wherein said opening is a slot-type opening for receiving at least a portion of a wire handle of a pre-packaged ready-to-pop style container of popcorn capable of being heated by holding such container over a heating source.

5. A cooking implement according to claim 1 wherein said holding member includes a substantially flat portion and two raised panel members operably connected to said substantially flat portion on a first predetermined side thereof, said raised panel members being parallel to said substantially flat portion, thereby creating said opening.

6. A cooking implement according to claim 1 wherein said holding member is formed in two halves and is hinged.

7. A cooking implement according to claim 1 wherein said cooking implement includes an insulated ring disposed around at least a portion of said elongated extending arm at a predetermined location thereon.

8. A cooking implement according to claim 1 wherein said first predetermined material is heat resistant.

9. A cooking implement according to claim 1 wherein said first predetermined material is a metal.

10. A cooking implement according to claim 9 wherein said metal is aluminum.

11. A cooking implement according to claim 1 wherein said second predetermined material is heat resistant.

12. A cooking implement according to claim 1 wherein said second predetermined material is a metal.

13. A cooking implement according to claim 12 wherein said second predetermined material is aluminum.

14. A cooking implement according to claim 1 wherein said third predetermined material is wood.

15. A cooking implement according to claim 1 wherein said fourth predetermined shape is substantially cylindrical.

16. A cooking implement according to claim 1 wherein said second predetermined shape is substantially rectangular.

17. A cooking implement according to claim 1 wherein said first predetermined length is between about 14.0 inches and 32.0 inches long.

18. A cooking implement according to claim 2 wherein said heat resistant handle member is between about 4.0 inches and 8.0 inches long.

19. A cooking implement according to claim 1 wherein said holding member is between about 4.0 inches and 6.0 inches long.

20. A cooking implement according to claim 1 wherein said holding member is between about 1.5 inches and 2.5 inches wide.
